(19) United States
(12) Patent Application Publication
(10) Pub. No.: US 2011/0154613 A1
(43) Pub. Date: Jun. 30, 2011

(54) HINGE

(75) Inventor: JUNG-BIN CHANG, Tu-Cheng (TW)

(73) Assignee: HON HAI PRECISION INDUSTRY CO., LTD., Tu-Cheng (TW)

(21) Appl. No.: 12/647,409

(22) Filed: Dec. 25, 2009

(51) Int. Cl. E05D 11/00

(52) U.S. Cl. 16/273

(57) ABSTRACT

A hinge includes a first leaf, a second leaf, and a pivot shaft. The pivot shaft includes a first pivot pin pivotably mounted to the first leaf and a second pivot pin pivotably mounted to the second leaf. A friction between the second leaf and the pivot shaft is smaller than a friction between the first leaf and the pivot shaft. The pivot shaft forms a ledge, and the second leaf correspondingly forms a tab to engage with the ledge. Upon the condition that the tab engages with the ledge such that the pivot shaft can rotate with the second leaf, a larger twisting force is needed for the second leaf, together with the pivot shaft, to rotate relative to the first leaf due to the larger friction between the first leaf and the pivot shaft.

### CROSS-REFERENCE TO RELATED APPLICATION

A relevant subject matter is disclosed in a co-pending U.S. patent application (Attorney Docket No. US30359) filed on the same date and entitled “HINGE,” which is assigned to the same assignee as this patent application.

### BACKGROUND

1. Technical Field

The present disclosure relates to a hinge.

2. Description of Related Art

A foldable device, such as a notebook computer, or a foldable mobile phone, generally includes a base and a cover pivotably mounted to the base via a hinge. The hinge generally includes a pivot shaft, a first leaf, and a second leaf. The first leaf is mounted to the base, and the second leaf is mounted to the cover. A twisting force is required to overcome a friction between the second leaf and the pivot shaft to rotate the cover relative to the base. However, the friction between the second leaf and the pivot shaft remains the same when the device is unfolded. The twisting force required also remains the same, which gives a user an uneasy feeling.

### BRIEF DESCRIPTION OF THE DRAWINGS

FIG. 1 is an exploded, isometric view of a first exemplary embodiment of a hinge.

FIG. 2 is an assembled, isometric view of the hinge of FIG. 1.

FIG. 3 is similar to FIG. 2, but showing a different state.

FIG. 4 is an exploded, isometric view of a second exemplary embodiment of a hinge.

FIG. 5 is similar to FIG. 4, but viewed from another perspective.

FIG. 6 is an assembled, isometric view of the hinge of FIG. 4.

FIG. 7 is similar to FIG. 6, but showing a different state.

### DETAILED DESCRIPTION

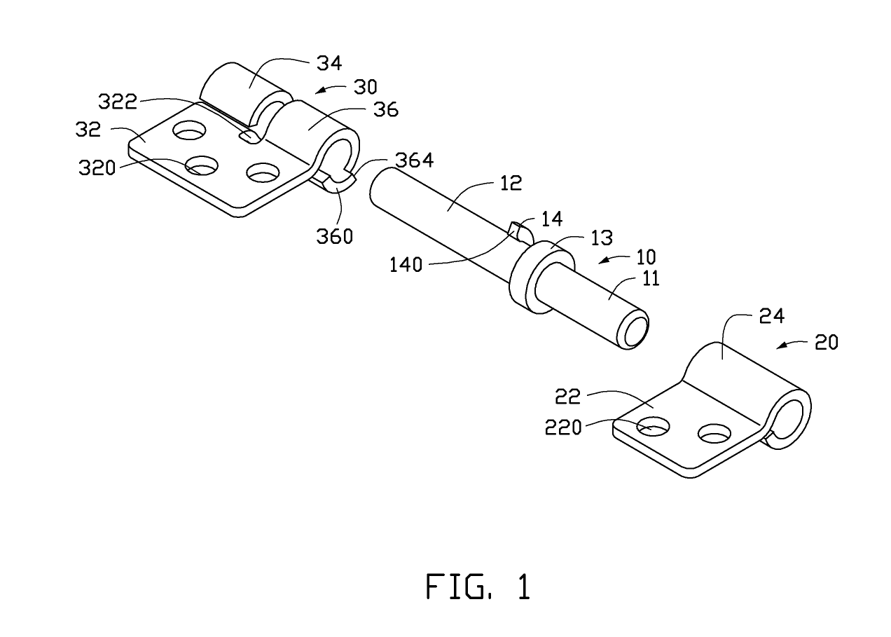

Referring to FIG. 1, a first exemplary embodiment of a hinge includes a pivot shaft 10, a first leaf 20, and a second leaf 30.

The pivot shaft 10 includes a first pivot pin 11, a second pivot pin 12, and a flange 13. The flange 13 is positioned between the first pivot pin 11 and the second pivot pin 12. A ledge 14 protrudes partially around the second pivot pin 12, adjacent to the flange 13. Two engaging surfaces 140 are formed on opposite ends of the ledge 14.

The first leaf 20 includes a mounting piece 22 defining two fixing holes 220 to fix the first leaf 20 to a base of a foldable device, such as a notebook computer. A side of the mounting piece 22 is curled to form a knuckle 24. The first pivot pin 11 rotatably extends through the knuckle 24. When the knuckle 24 rotates relative to the first pivot pin 11, a friction between the first pivot pin 11 and the knuckle 24 is f1.

The second leaf 30 includes a mounting piece 32 defining a plurality of fixing holes 320 to fix the second leaf 30 to a cover of the foldable device. A center of a side of the mounting piece 32 defines an incision 322. The side is curled from two sides of the incision 322 in different directions, forming a first knuckle 34 and a second knuckle 36. The first knuckle 34 is coaxial with the second knuckle 36, and an inner diameter of the first knuckle 34 is equal to that of the second knuckle 36. The second pivot pin 12 is rotatably received in the first knuckle 34 and the second knuckle 36. When the second pivot pin 12 rotates relative to the first knuckle 34 and the second knuckle 36, a friction between the second pivot pin 12 and the first knuckle 34 and the second knuckle 36 is f2. An arc-shaped tab 360 axially extends from one end of the second knuckle 36 away from the first knuckle 34. The tab 360 is corresponding to the ledge 14. Two engaging surfaces 364 are formed on opposite sides of the tab 360.

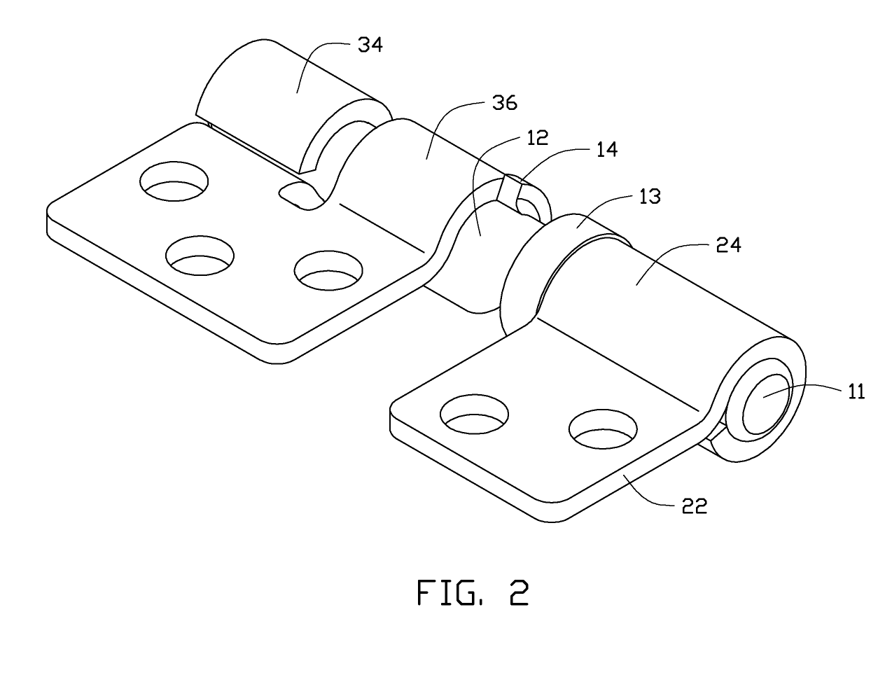

Referring to FIG. 2, during assembly, the knuckle 24 is knuckled on the first pivot pin 11. The second leaf 30 is sleeved on the second pivot pin 12 such that the flange 13 locates between the knuckle 24 and the second knuckle 36. The friction f2 between the second pivot pin 12 and the first knuckle 34 and the second knuckle 36 of the second leaf 30 is smaller than the friction f1 between the first pivot pin 11 and the knuckle 24. In one exemplary embodiment, an inner diameter of the knuckle 24, the first knuckle 34 and the second knuckle 36 are the same, while a diameter of the first pivot pin 11 is larger than that of the second pivot pin 12, as a result, the friction f1 is larger than the friction f2.

In other exemplary embodiments, an inner wall of the knuckle 24 and a circumference of the first pivot pin 11 form friction pattern to increase the friction between the knuckle 24 and the first pivot pin 11. Or the diameter of the first pivot pin 11 is equal to that of the second pivot pin 12, the inner diameter of the knuckle 24 is reduced to make the friction f1 larger than the friction f2. Or the diameter of the first pivot pin 11 is equal to that of the second pivot pin 12, the inner diameters of the first knuckle 34 and the second knuckle 36 are increased to make the friction f1 larger than the friction f2.

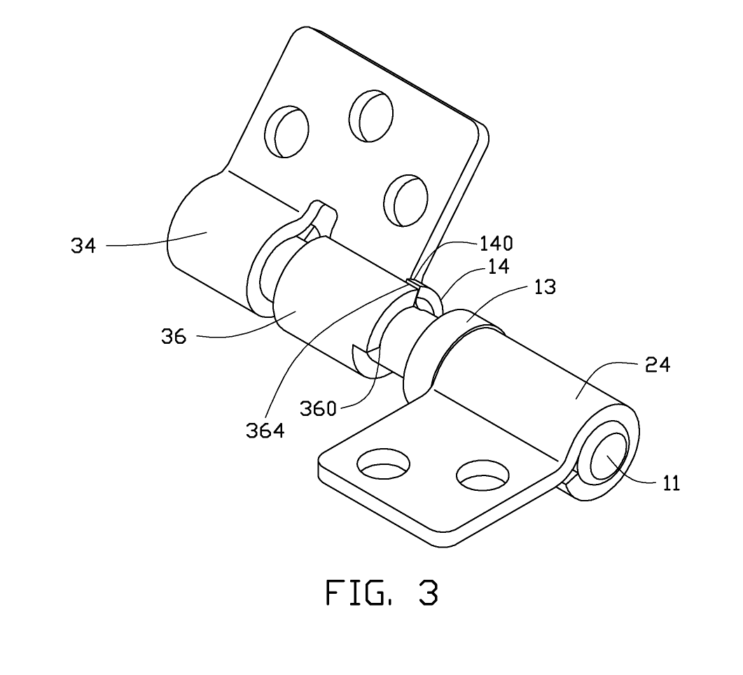

Referring to the FIG. 3, to open the foldable device from a folded/closed state, initially, a smaller twisting force is required to overcome the friction f2 between the first knuckle 34, the second knuckle 36 of the second leaf 30 and the second pivot pin 12 to rotate the second leaf 30 relative to the pivot shaft 10. This is because the friction f2 between the second leaf 30 and the pivot shaft 10 is smaller than the friction f1 between the first leaf 20 and the pivot shaft 10. When one of the engaging surfaces 364 of the tab 360 engages with one of the engaging surfaces 140 of the ledge 14, a larger twisting force is required to overcome the friction f1 between the knuckle 24 and the first pivot pin 11 to simultaneously rotate the second leaf 30 and the pivot shaft 10 relative to the first leaf 20.

To close the foldable device from the unfolded/opened state, initially, a smaller twisting force is required to overcome the friction f2 between the first knuckle 34, the second knuckle 36 and the second pivot pin 12 to rotate the second leaf 30 relative to the pivot shaft 10. When the other engaging surface 364 of the second leaf 30 engages with the other engaging surface 140 of the pivot shaft 10, a larger twisting force is required to overcome the friction f1 between the knuckle 24 and the first pivot pin 11 to simultaneously rotate the second leaf 30 and the pivot shaft 10 relative to the first leaf 20.

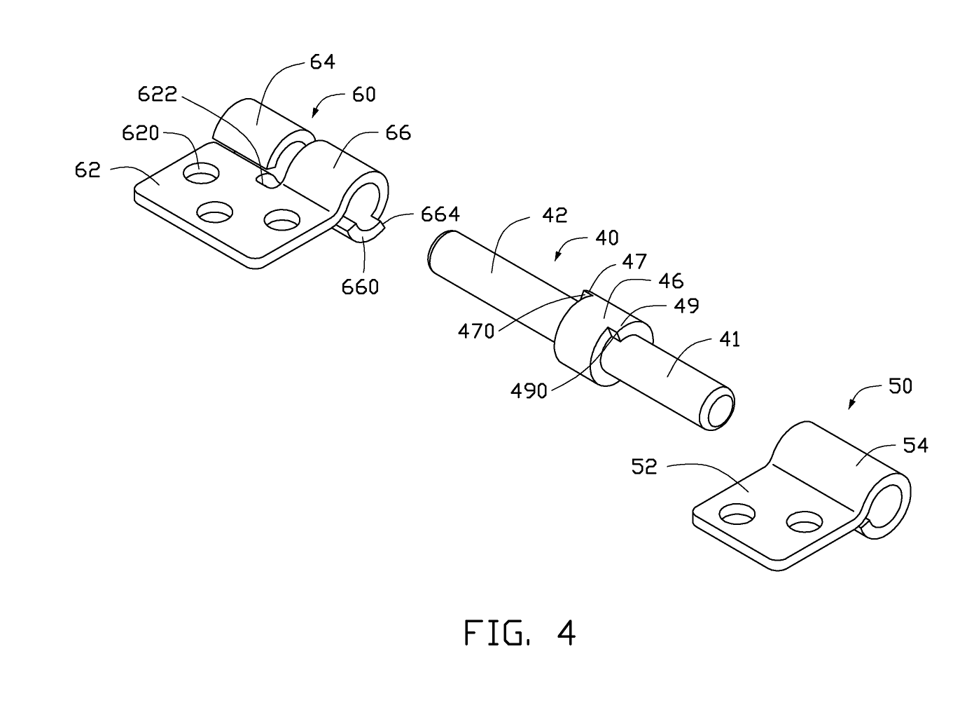

Referring to FIG. 4, a second exemplary embodiment of a hinge includes a pivot shaft 40, a first leaf 50, and a second leaf 60.

The pivot shaft 40 includes a first pivot pin 41, a second pivot pin 42, and a flange 46. The flange 46 is positioned between the first pivot pin 41 and the second pivot pin 42. An arc-shaped ledge 47 extends from a first end of the flange 46, adjacent to the second pivot pin 42. Two engaging surfaces 470 are formed on opposite ends of the ledge 47. A wall 49 protrudes from a second end of the flange 46, adjacent to the first pivot pin 41. The wall 49 is arc-shaped. Two blocking surfaces 490 are formed on opposite ends of the wall 49.

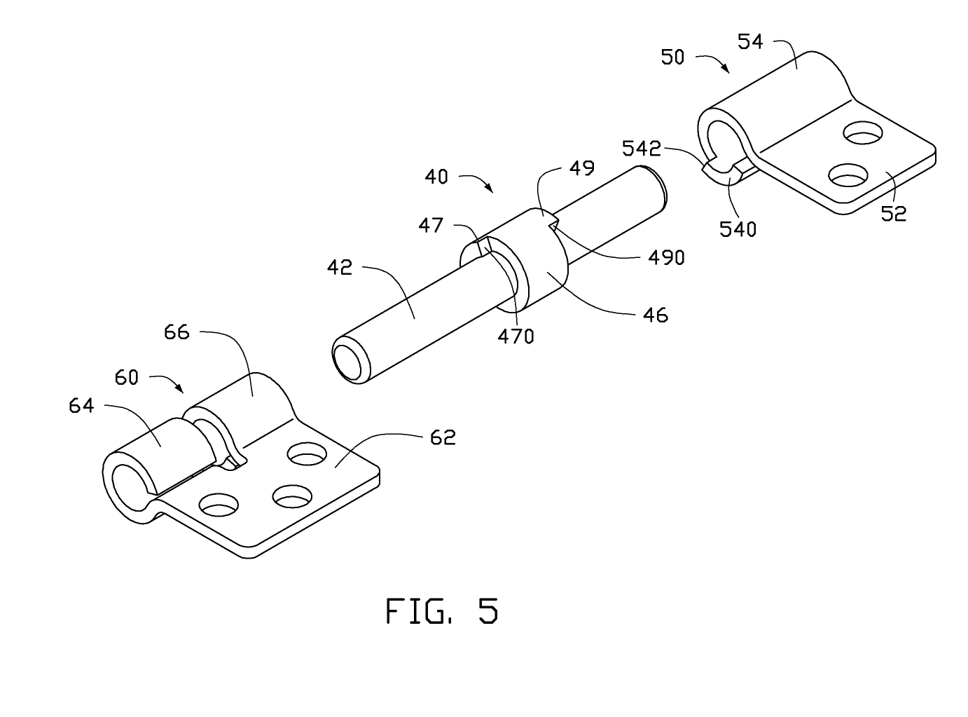

Referring to FIG. 5, the first leaf 50 includes a mounting piece 52 defining two fixing holes 520 to fix the first leaf 50 to a base of a foldable device, such as a notebook computer. A side of the mounting piece 52 is curled to form a knuckle 54. The first pivot pin 41 of the pivot shaft 40 rotatably extends through the knuckle 54. When the first pivot pin 41 rotates relative to the knuckle 54, a friction between the first pivot pin 41 and the knuckle 54 is f3. A positioning portion 540 axially extends from one end of knuckle 54. The positioning portion 540 is corresponding to the wall 49. Two positioning surfaces 542 are formed on opposite ends of the positioning portion 540.

The second leaf 60 includes a mounting piece 62 defining a plurality of fixing holes 620 to fix the second leaf 60 to a cover of the foldable device. A center of a side of the second leaf 60 defines an incision 622. The side is bent and extends curled from two sides of the incision 622 in different directions, forming a first knuckle 64 and a second knuckle 66. The first knuckle 64 is coaxial with the second knuckle 66, and an inner diameter of the first knuckle 64 is equal to an inner diameter of the second knuckle 66. When the second pivot pin 42 rotates relative to the first knuckle 64 and the second knuckle 66, a friction between the second pivot pin 42 and the first knuckle 64, the second knuckle 66 of the second leaf 60 is f4. An arc-shaped tab 660 axially extends from one end of the second knuckle 66 away from the first knuckle 64. The tab 660 is corresponding to the ledge 47. Two engaging surfaces 664 are formed on opposite ends of the tab 660.

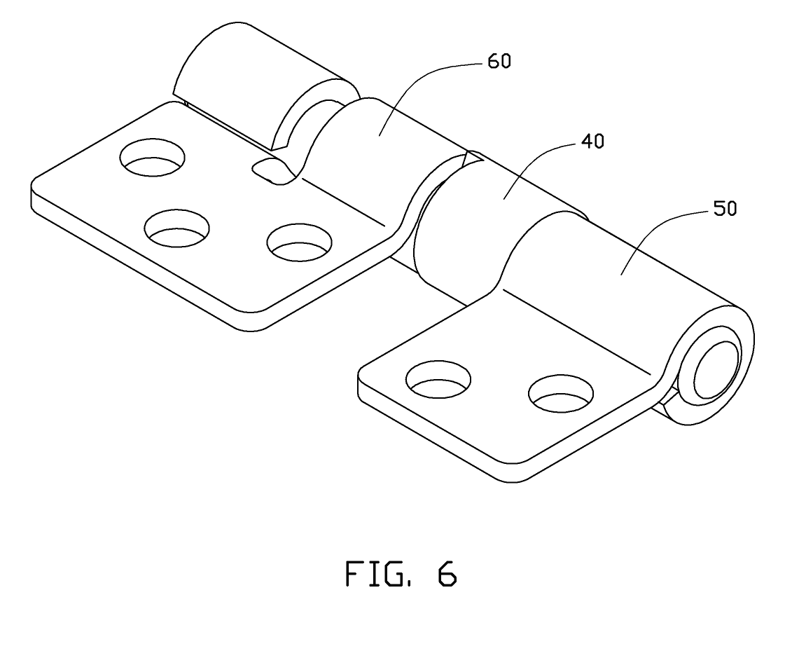

Referring to FIG. 6, during assembly, the first pivot pin 41 extends through the knuckle 54. The second leaf 60 is sleeved on the second pivot pin 42 such that the flange 46 locates between the knuckle 54 and the second knuckle 66. The friction f4 between the second pivot pin 42 and the first knuckle 64, the second knuckle 66 of the second leaf 60 is smaller than the friction f3 between the first pivot pin 41 and the knuckle 44. In one exemplary embodiment, an inner diameter of the knuckle 54, the first knuckle 64 and the second knuckle 66 are the same, while a diameter of the first pivot pin 41 is larger than that of the second pivot pin 42, as a result, the friction f3 is larger than the friction f4.

In other exemplary embodiments, an inner wall of the knuckle 54 and a circumference of the first pivot pin 41 form friction pattern to increase the friction between the knuckle 54 and the first pivot pin 41. Or the diameter of the first pivot pin 41 is equal to that of the second pivot pin 42, the inner diameter of the knuckle 54 is reduced to make the friction f3 larger than the friction f4. Or the diameter of the first pivot pin 41 is equal to that of the second pivot pin 42, the inner diameters of the first knuckle 54 and the second knuckle 56 are increased to make the friction f3 larger than the friction f4.

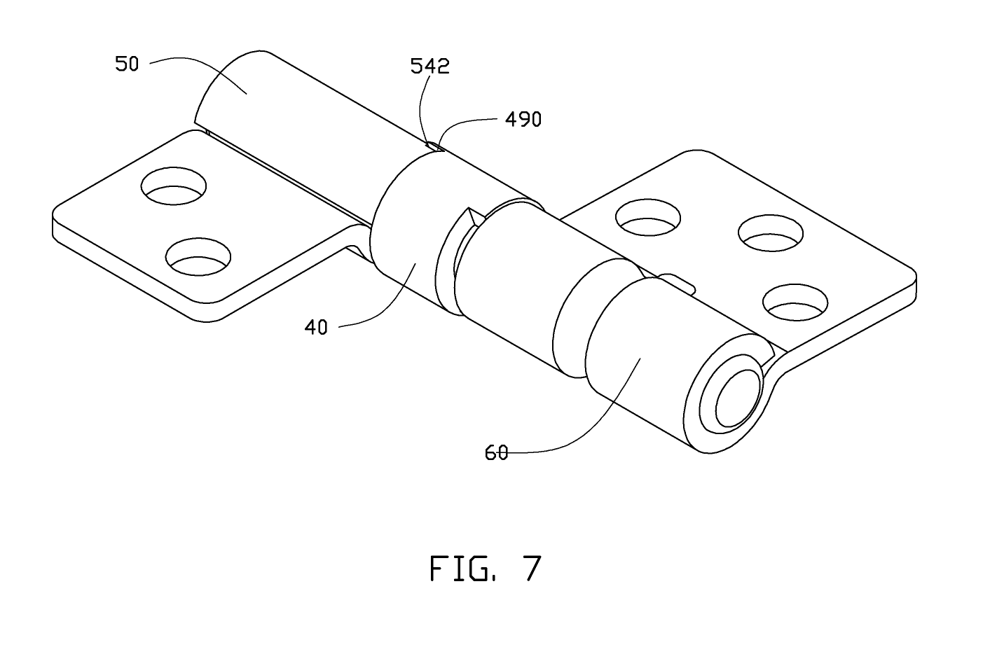

Referring to the FIG. 7, to open the foldable device from a folded/closed state, initially, a smaller twisting force is required to overcome the friction f4 between the first knuckle 64, the second knuckle 66 of the second leaf 60 and the second pivot pin 42 to rotate the second leaf 60 relative to the pivot shaft 50. This is because the friction f4 between the second leaf 60 and the pivot shaft 40 is smaller than the f3 between the first leaf 50 and the pivot shaft 40. When one of the engaging surfaces 664 of the second leaf 60 engages with one of the engaging surfaces 470 of the pivot shaft 40, a larger twisting force is required to overcome the friction f3 between the knuckle 54 and the first pivot pin 41 to simultaneously rotate the second leaf 60 and the pivot shaft 40 relative to the first leaf 50. When one of the blocking surfaces 490 engages with one of the positioning surfaces 542, the first leaf 50 prevents the second leaf 60 and the pivot shaft 40 from simultaneously rotating relative to the first leaf 50.

To close the foldable device from the unfolded/opened state, initially, a smaller twisting force is required to overcome the friction f4 between the first knuckle 64, the second knuckle 66 of the second leaf 60 and the second pivot pin 42 to rotate the second leaf 60 relative to the pivot shaft 40. When the other engaging surface 664 of the second leaf 60 engages the other engaging surface 470 of the pivot shaft 40, a larger twisting force is required to overcome the friction f3 between the knuckle 54 of the first leaf 50 and the first pivot pin 41 to simultaneously rotate the second leaf 60 and the pivot shaft 40 relative to the first leaf 50.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A hinge comprising,
a first leaf;
a second leaf; and
a pivot shaft comprising a first pivot pin pivotably mounted to the first leaf and a second pivot pin pivotably mounted to the second leaf, wherein a friction between the second leaf and the pivot shaft is smaller than a friction between the first leaf and the pivot shaft, wherein the pivot shaft forms an ledge, and the second leaf correspondingly forms a tab to engage with the ledge, and wherein upon the condition that the tab engages with the ledge such that the pivot shaft can rotate with the second leaf, a larger twisting force is needed for the second leaf, together with the pivot shaft, to rotate relative to the first leaf due to the larger friction between the first leaf and the pivot shaft.

2. The hinge of claim 1, wherein two ends of the ledge of the pivot shaft respectively forms an engaging surface, correspondingly two ends of the tab of the second leaf respectively forms an engaging surface to engage with a corresponding engaging surface of the ledge.

3. The hinge of claim 1, wherein the first leaf comprises a knuckle through which the first pivot pin of the pivot shaft pivotably extends, the second leaf comprises a first knuckle and a second knuckle having an inner diameter same to the first knuckle and coaxial with the first knuckle, the second pivot pin of the pivot shaft pivotably extends through the first and second knuckles.

4. The hinge of claim 3, wherein the second leaf further comprises a mounting piece, a side of the mounting piece of the second leaf defines an incision, the first and second knuckles are reversely curled from the side of the mounting piece, at opposite sides of the incision.

5. The hinge of claim 4, wherein the tab extends from one end of the second knuckle away from the first knuckle.

6. The hinge of claim 1, wherein a flange is defined between the first pivot pin and the second pivot pin, the ledge protrudes partially around the second pivot pin, adjacent to the flange, to engage with the second leaf.

7. The hinge of claim 1, wherein a flange is formed between the first pivot pin and the second pivot pin, a first end of the flange adjacent to the second pivot pin forms the ledge to engage with the second leaf.

8. The hinge of claim 7, wherein a second end of the flange adjacent to the first pivot pin forms a wall, the first leaf comprise a knuckle through which the first pivot pin of the pivot shaft pivotably extends, one end of the knuckle forms a positioning portion, to engage with the wall of the of the flange.
